(19) United States
(12) Patent Application Publication
(10) Pub. No.: US 2013/0202777 A1
(43) Pub. Date: Aug. 8, 2013

(54) FUNCTIONAL HEMP PROTEIN EXTRACTION

(71) Applicant: Robert Davis, Port Townsend, WA (US)

(72) Inventor: Robert Davis, Port Townsend, WA (US)

(73) Assignee: The Hemp Food Company, Port Townsend, WA (US)

(21) Appl. No.: 13/755,523

(22) Filed: Jan. 31, 2013

Related U.S. Application Data
(60) Provisional application No. 61/595,046, filed on Feb. 4, 2012.

(51) Int. Cl. A23J 3/22

(52) U.S. Cl. CPC A23J 3/22
USPC 426/656

(57) ABSTRACT

A protein development process including soaking and cleaning the hemp as necessary, combining the hemp and water in a desired ratio and emulsifying the mixture in a high shear processing blender until green oil is evident, and add protein, if desired.

### TECHNICAL FIELD

This invention pertains generally to a protein development process, and more specifically to an ambient or cold temperature mechanical process that converts hemp seed with shell protein, emulsifying it to a gluten-like matrix to contribute functionally and nutritionally in food product development including meat analog, textured vegetable protein, and pet food products as well as chips crackers, cereal nuggets, and the like.

### BACKGROUND OF THE INVENTION

Generally, meat analogs are made from non-meats, but sometimes include animal products such as dairy. The market for meat imitations includes vegetarians, vegans, non-vegetarians seeking to reduce their meat consumption for health or ethical reasons, and people following religious dietary laws. Nuts, seeds, soy products, cereal, eggs and dairy are all good meatless protein choices.

However, many vitamins and minerals are leached away during high-heat production processes. Furthermore, some people may have trouble digesting conventional meat analogs or experience intolerances to ingredients like gluten and monosodium glutamate (MSG). In particular, soy has in recent years fallen into disfavor due to its hexane processing along with its frequent genetically modified organism (GMO) status.

Additionally, there are applications of protein in grain-type products such as chips, crackers, and cereal nuggets. Because of the increasing interest in fortifying foods such as snack foods and breakfast cereals with a broad range of nutrient, the demand for protein products has greatly increased.

### DISCLOSURE OF THE INVENTION

The present invention solves the above-mentioned problems by providing a simple and effective way to extract the protein from hemp elements in order that they may contribute functionally and nutritionally in food product development including meat analog, textured vegetable protein, and pet food products as well as chips crackers, cereal nuggets, and the like. The Functional Hemp Protein Extraction Process utilizes de-hulled hemp nut and/or hulled hemp seed and water. It is an initial ambient or cold temperature process that utilizes high shear emulsion equipment. It is important to note that this process does not require cooking 180 to 211° F. at any point during the extraction process. The process though effective at 75 degrees F. may reach higher temperatures (up to 170° F.) due to friction during the emulsion time frame which can take up to 10 minutes. Optimally the entire process from start to finish should be performed in the approximate range of 80° F. to 120° F. High heating during extraction can destroy nutrients, but in order to render the cold emulsion into a finished analog, heat will be applied. In fact, high heat (180 F/212° F.) is critical to all down-line applications (after extraction) due to the fact that heat sets the functional hemp protein matrix. (180 F to 212° F.).

The basic steps of the hemp protein extraction process are roughly as follows:

1. Establishing the amounts of hemp element (nut or seed) and water (the ratio of these two elements should be approximately within the range of 100% Hemp to 0% water through 100% Hemp with 30% water. The optimum range for meat analogs is Hemp 100% and water variance from 10% to 25%.

2. The Key is Emulsifying the hemp/water system till the matrix turns a light green and oil is released (and appears in the blender as a sheen on the surface of the emulsified hemp matrix or free oil that is visible to the eye in the emulsified matrix).

3. Freeing the oil from the resulting hemp protein and fiber emulsion so as to activate the hemp protein and fiber emulsion to perform as a functional standalone or binding protein; and

4. Optional step—adding key additional proteins such as pea, soy, wheat, or rice, in order to embellish the hemp protein in forming certain meat analogs and/or pet food products.

### BRIEF DESCRIPTION OF THE DRAWING

FIG. 1 is an overview block diagram of the basic process of the invention.

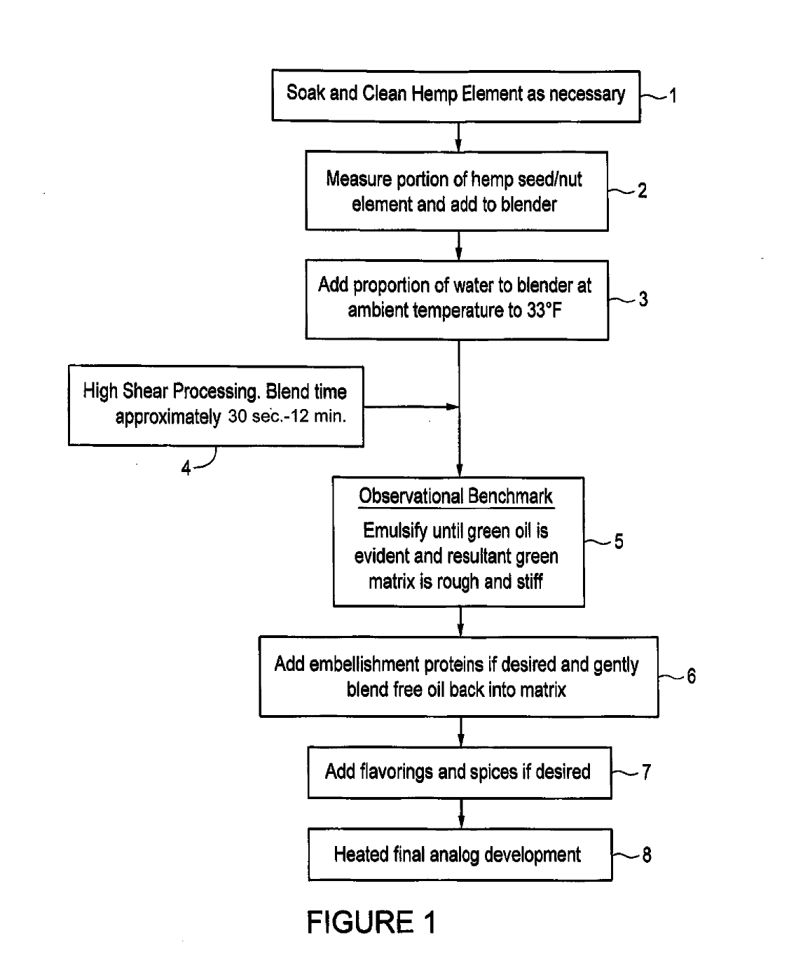

### BEST MODE FOR CARRYING OUT THE INVENTION

The first step of the process is to establish the amounts of hemp element (nut or seed) and water. The ratio of these two elements should be approximately within the range of 100% Hemp to 0 to 30% water but will vary according to several factors. The exact proportions of these two ingredients will vary depending upon the target application. For instance, if the target product is vegan meat, the ratio of hemp element to water will be different from the ratio if the target product is pet food. Generally, baby food will require a more dilute mixture than other target products. A suggested range for the two ingredients may be: hemp element 100%; water 30%-0%. The key range for meat analogs for water is 10-25%, less water for a firmer style heat setting matrix and more for a less functional heat setting matrix.(When used to make tortilla chips, crackers and baked items) (1-3).

The second step 4 is to emulsify the hemp/water system (or dry hemp system if the proportion of water is 0%) at ambient or cold temperatures till the matrix turns a light green color and oil is released (by a sheen on the surface of the Hemp or in the blender as free oil). A high shear friction process is used to emulsify the hemp/water mixture. High speed chopping blades shear the hemp element and release the oil within. The oil is released but not removed. This process can take up to 10 minutes and depending on the Hemp substrate i.e. Hemp Whole Seed, Hemp Nut or Hemp Fines can build temperature (dull blades in the emulsifier) up to 170° F. Normal processing and extraction can be achieved in the chilled to ambient 75/80° F. temperature range. Because the necessary emulsion is generally not achievable with a conventional style grinder (as may be used in other hemp grinding programs), it is suggested that a blender such as a Bowl Chopper, Vertical Emulsifier or Silent Cutter-type of high shear emulsion equipment, common to the sausage industry, may be used for this step with success. Thus, the emulsion will be frictionally released instead of chemically or otherwise. The high shear emulsion process typically allows for the hemp element to be sheared in approximately 30 seconds to 12 minutes, depending on the sharpness of the blades and shear strength of the emulsifier, concurrently freeing the oil.

Moreover, the particular hemp element to be used (nut or seed) will also be informed by the target application or product. The particular hemp element may be clean and fresh de-hulled hemp nut or clean and fresh hulled hemp seed.

As the oil is released, the emulsion gradually turns green 5. The free oil then indicates that the hemp protein and fiber emulsion has been rendered into a positive functional protein from the hemp matrix. The free oil and/or sheen on the matrix surface is considered a primary observational benchmark inherent to this process and confirms the adequate functional nature of the hemp protein. The protein, being at this point analogous to a heat setting wheat gluten or a standard heat setting meat emulsion, is now considered activated and can perform as a functional standalone or binding protein.

The resulting meat analog's functional attributes may be embellished by the addition of other key proteins 6. Such additions are typically of textured vegetable proteins such as pea, soy, wheat, or rice. More dilute admixtures (adding more water) of the hemp emulsion with other proteins 7 can be used in products desiring this hemp- based protein blend with minimal textural qualities. More water lessens the functional quality per the objective of creating the texture of wheat gluten and meat. For instance, a creamed protein baby food would be one of the applications. The hemp protein can be removed from the emulsifier when the new proteins are blended and emulsified and then added back in to create a homogenous protein blend.

Up to this point, this system has been a non-heated system, other than the naturally occurring friction temperatures (75 F/170° F.) based on the specific density of the hemp substrate and the sharpness of the emulsification equipment blades. At this point, the hemp protein has been activated and can follow conventional food product production processing, which may include high heating steps 180/212° F. (8). For instance, the now functional cold/ambient matrix can be blended with flavorings and spices and stuffed into casings to make hot dog/bologna style products or formed into patties and pre-cooked. Alternatively, the hemp matrix, either individually or with additional embellishment proteins, can be dried into jerky, developed into pet food, chips, crackers, cereal nuggets, etc., or set up via heating into other desired forms. The products can then be chilled and packed in accordance with normal processing procedures of meat, meat analog, or other food packaging.

What is claimed is:

1. A protein development process utilizing hemp, comprising the steps of:
a) soak and clean the hemp element as necessary;
b) measure hemp seed/nut element to add to high shear processing blender;
c) add water to blender in proportion to desired end product;
d) emulsify until green oil is evident and green matrix is rough and stiff, forming a gluten-like matrix; and
e) add protein if desired and blend free oil back into the matrix, which ameliorates the protein quality.
